(19) United States
(12) Patent Application Publication
(10) Pub. No.: US 2006/0151505 A1
(43) Pub. Date: Jul. 13, 2006

(54) Fuel tank for motor vehicle and method for producing the same

(75) Inventor: Masahide Kobayashi, Toyota-shi (JP)

Correspondence Address: POSZ LAW GROUP, PLC, 12040 SOUTH LAKES DRIVE, SUITE 101, RESTON, VA, 20191, US

(73) Assignee: FTS CO., LTD., Inazawa-shi (JP)

(21) Appl. No.: 11/325,625

(22) Filed: Jan. 5, 2006

(30) Foreign Application Priority Data
Jan. 11, 2005 (JP) 2005-003381

(51) Int. Cl. B62D 33/00

(52) U.S. Cl. 220/562

(57) ABSTRACT

A fuel tank for a motor vehicle, which exhibits high fuel permeation preventing properties and a sufficiently good rigidity, and can be manufactured readily with an excellent quality, and the method for producing such a fuel tank. The fuel tank has an upper tank and a lower tank which are respectively composed of a thermoplastic synthetic resin. Peripheral parts around open ends of the upper tank and the lower tank are joined together to form the fuel tank. The upper tank and the lower tank respectively have an inner resin layer and an outer resin layer. The outer resin layer is previously formed by preforming a thermoplastic synthetic resin sheet, and the inner resin layer is formed on an interior surface of the outer resin layer by injection molding. Ribs are integrally formed in the inner resin layer so as to project into an interior of each tank.

### CROSS-REFERENCE TO RELATED APPLICATION

This application is related to and claims priority from Japanese patent application No. 2005-003381, incorporated herein by reference.

### BACKGROUND OF THE INVENTION

1. Field of the Invention

The present invention relates to a fuel tank for a motor vehicle, which includes a pair of injection-molded parts, that is an upper tank and a lower tank, and a method for producing the fuel tank by joining the upper tank and the lower tank together.

2. Description of Related Art

Conventionally, fuel tanks for motor vehicles have been formed of metal. But, recently, fuel tanks formed of a thermoplastic synthetic resin have been frequently used, because it is lightweight, free from rust, and readily formed into a desired configuration.

In many cases, the fuel tanks formed of thermoplastic synthetic resin have been produced with the blow molding method, because tubular bodies can be readily formed therewith. With the blow molding method, a cylindrical-shaped parison composed of a molten synthetic resin is extruded into a mold from the upper side thereof, and air is blown into the parison while holding the parison with the mold.

However, where great-sized tubular products such as the fuel tanks for motor vehicles are produced with the blow molding method, the weight of the parison increases. And where walls of the fuel tanks are made thick to increase the strength thereof, the weight of the parison increases, too. In these cases, when the molten parison is extruded into the mold from the upper side thereof, the molten parison sages downwardly with its own great weight, and consequently, the wall thickness of molded products may decrease from the lower side to the upper side thereof.

In case of products having complicated configurations, such as fuel tanks for motor vehicles, when the parison is expanded in the mold, the expansion ratio of the parison may vary with the position of the products. As a result, the wall thickness of the molded products may scatter.

The fuel tanks for motor vehicles, which are prepared with the blow molding method, are difficult to provide ribs, beams, etc. therein. In addition, as described above, the expansion ratio of the parison may vary with the positions of the fuel tanks, and consequently, the wall thickness of the fuel tanks may scatter. Accordingly, considerable work and time have been required for the control of the wall thickness and the product quality. Furthermore, it has been difficult to attach accessories such as fuel valves, etc. to an interior of the fuel tanks.

For the above-described reasons, conventionally, an upper tank and a lower tank have been separately formed of a synthetic resin by injection molding, etc., and they have been fusion welded at their joint areas.

Examples of the method of forming the upper tank and the lower tank include the method of press forming a sheet-shaped laminated body composed of an inner layer, a permeation preventing layer and an outer layer to obtain an upper body and a lower body, respectively, and fusion welding the upper body and the lower body together (see Publication of unexamined patent application No. Hei 5-16938, ex.). However, when the sheet-shaped laminated body is subjected to press forming, it is difficult to form the laminated body having an increased thickness, and it is difficult to produce tanks with sufficiently great strength. In addition, it is also difficult to form projections etc. on interior surfaces and exterior surfaces of the tanks. And upon press forming, the fuel permeation preventing layer may be locally stretched to lower the fuel permeation preventing properties thereof.

In another method, a layer having a fuel permeation preventing function is preformed by vacuum molding, and a protecting layer is formed thereon by injection molding. Then, the obtained upper body and the lower body are joined together by fusion welding (see Publication of unexamined patent application No. Hei 10-157738, ex.). However, with this method, the film-shaped laminated body may be broken due to the pressure and heat during the injection molding.

In addition, another method of forming a base layer by injection molding, and forming a fuel permeation preventing barrier layer by injection molding has been proposed (see Publication of unexamined patent application No. 2004-98886, ex.). With this method, the injection molding process must be carried out two times for forming the base layer and the barrier layer, whereby the injection molding process may become complicated.

Furthermore, there has been also proposed a method of preforming a laminated body including a permeation preventing layer and an outer layer into a configuration similar to a finished product, and forming an inner layer by compression molding of a molten material (see Publication of unexamined patent application No. Hei 5-104552, ex.). With this method, the inner layer is formed by compression molding while directly contacting the permeation preventing layer so that the permeation preventing layer may be broken, or may be stretched into a thin wall thickness during compression molding. As a result, the fuel permeation preventing properties may be lowered.

### SUMMARY OF THE INVENTION

Accordingly, it is an object of the present invention to provide a fuel tank for a motor vehicle, which exhibits high fuel permeation preventing properties and sufficiently good stiffness, and can be readily produced with excellent quality, and provide a method for producing the same.

The fuel tank in accordance with the present invention includes an upper tank and a lower tank which are respectively composed of a thermoplastic synthetic resin, and of which peripheral parts around open ends thereof are joined together to form the fuel tank. The upper tank and the lower tank are respectively composed of an inner resin layer and an outer resin layer. The outer resin layer is formed by preforming a thermoplastic synthetic resin sheet. The inner resin layer is formed on an interior surface of the outer resin layer by injection molding, and projections are integrally formed in the inner resin layer so as to project into an interior of each tank.

With the fuel tank thus arranged, the upper tank and the lower tank can be formed separately. By injection molding, the upper tank and the lower tank, each having a high dimensional accuracy and a high strength, can be obtained. Accordingly, the fuel tank of a synthetic resin, which includes the upper tank and the lower tank joined together, has a high dimensional accuracy, a precise configuration and a high strength. In addition, reinforcement ribs, built-in parts, etc. can be readily attached inside and outside the upper tank and the lower tank.

By joining the peripheral parts of the upper tank and the lower tank together, the upper tank and the lower tank, which have been formed separately, can be made into one body readily and securely. As a result, the fuel tank free from oil leakage in joined parts can be obtained. Since the upper tank and the lower tank are composed of the same material as each other, strong joining can be effected.

The upper tank and the lower tank respectively consist of an inner resin layer and an outer resin layer so that these layers may be composed of a combination of resins exhibiting different properties. The inner resin layer may be composed of a synthetic resin exhibiting high fuel permeation preventing properties.

The outer resin layer is formed by preforming a synthetic resin sheet. The synthetic resin sheet can be readily formed by extruding a synthetic resin. By preforming the synthetic resin sheet, the outer resin layer with a uniform thickness can be readily formed.

The inner resin layer is formed on the interior surface of the outer resin layer by injection molding, and the projections such as ribs are integrally formed in the inner resin layer so as to project into an interior of each tank. Therefore, the inner resin layer can be formed on the interior surface of the outer resin layer uniformly. Due to the injection molding of the inner resin layer, the outer resin layer can be brought into close contact with the mold, whereby the dimensions of the upper tank and the lower tank can be formed with accuracy. And due to the heat and pressure of the injection molding, the outer resin layer and the inner resin layer can be readily bonded.

Since the projections are integrally formed in the inner resin layer so as to project into an interior of each tank, ribs can be formed in the inner resin layer to enhance the rigidity of the fuel tank, and projections can be formed in the inner resin layer to attach parts such as fuel feeding valves, etc. in the interior of the tank. In addition, these projections can be formed during the formation of the inner resin layer, the projections can be formed strongly.

It is preferable that the inner resin layer is composed of a thermoplastic synthetic resin of which the fuel permeation preventing properties are higher than those of the outer resin layer. With this arrangement, the strength of an outer wall of the fuel tank can be increased due to the outer resin layer. Since the thermoplastic synthetic resin is used, by heating the resin sheet, it can be readily made soft and preformed. In addition, by covering the inner resin layer having fuel permeation preventing properties with the outer resin layer, the fuel permeation preventing performance can be effected where the inner resin layer is thin.

It is preferable that in the peripheral parts of the upper tank and the lower tank, the inner resin layer of the upper tank and the inner resin layer of the lower tank contact each other and fusion welded together. With this arrangement, in joined parts of the upper tank and the lower tank, the resins, each having high fuel permeation preventing properties, are fusion welded together, thereby preventing fuel from permeating in the joined parts of the fuel tank.

It is preferable that an adhesive sheet is interposed between the outer resin layer and the inner resin layer, and the adhesive sheet includes a layer adapted to be bonded to the outer resin layer, and another layer adapted to be bonded to the inner resin layer. With this arrangement, the inner resin layer is bonded to the outer resin layer strongly, thereby increasing the strength of the fuel tank, and preventing fuel from permeating between the outer resin layer and the inner resin layer.

In accordance with the method of the present invention, for producing a fuel tank for a motor vehicle, which is composed of an upper tank and a lower tank which are separately molded, and of which peripheral parts around open ends thereof are joined together, the molding step of the upper tank and the lower tank includes the steps of preforming a resin sheet adapted to compose the outer resin layer, placing the formed resin sheet in a cavity of a mold, and injecting a synthetic resin adapted to compose the inner resin layer after closing the mold.

With this method, the upper tank and the lower tank can be molded separately so that a tubular tank with a complicated configuration can be readily formed. By molding, the upper tank and the lower tank, each having a high dimensional accuracy and a high strength, can be obtained so that the resultant fuel tank composed of the upper tank and the lower tank has a high dimensional accuracy, a precise configuration and a high strength.

The outer resin layer of each of the upper tank and the lower tank is formed by preforming a resin sheet adapted to compose the outer resin layer. This resin sheet can be readily formed by extruding a synthetic resin having a high rigidity. By preforming the resin sheet, the outer resin layer can be readily formed with a uniform wall thickness. By selecting the material for the resin sheet from various materials, the resin sheet can be preformed only by compression molding.

After the preformed resin sheet is placed in the cavity of the mold, the mold is closed. Then, the synthetic resin having excellent fuel permeation preventing properties is injected. With this method, the inner resin layer exhibiting excellent fuel permeation preventing properties can be formed on the interior surface of the preformed outer resin layer with a uniform thickness, whereby the fuel permeation preventing properties of the fuel tank can be ensured. In addition, by injection molding of the inner resin layer, the outer resin layer can be brought into close contact with the mold, and the inner resin layer flows at a high temperature to be brought into close contact with the outer resin layer, whereby both the interior surface and the exterior surface of each of the upper tank and the lower tank can conform to the mold surfaces with accuracy, and the outer resin layer and the inner resin layer can be readily bonded to each other. Since the resin sheet adapted to compose the outer resin layer is the resin having a high rigidity so as not to be broken or undesirably stretched during the injection molding of the inner resin layer.

It is preferable that the resin sheet adapted to compose the outer resin layer is preformed by heating the resin sheet and holding the heated resin sheet with the mold. With this method, by heating the resin sheet, the resin sheet becomes soft and can conform to the configuration of the cavity of the mold so as to facilitate the preforming of the resin sheet. The resin sheet is preformed by holding the heated resin sheet with the mold so that the mold for use in the injection molding of the inner resin layer can carry out both the preforming of the outer resin layer and the forming of the inner resin layer. Therefore, a mold for preforming is not needed, and consequently, the inner resin layer can be formed immediately after the preforming operation with good work efficiency.

It is preferable that upon preforming of the resin sheet, the heated resin sheet is held with the mold by pressing a peripheral part of the resin sheet with an outer frame of an upper mold, and a lower mold, lowering a central mold of the upper mold to press the resin sheet with the central mold of the upper mold and the lower mold, and it is preferable that the synthetic resin adapted to compose the inner resin layer is injected after the central mold is lowered and the resin sheet is pressed with the central mold and the lower mold. With this method, the resin sheet can be preformed with the central mold and the lower mold by lowering the central mold with the resin sheet pressed with the upper frame and the lower mold so that the resin sheet can be preformed with the mold for use in injection molding of the inner resin layer.

And with this method, the outer frame of the upper mold can prevent the material adapted to compose the inner resin layer from flowing out of the mold during pressure molding. The injection molding is carried out by lowering the central mold. The central mold is guided downwardly with the outer frame to define the cavity for forming the inner resin layer.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of one embodiment of a fuel tank in accordance with the present invention, which is seen from an obliquely upper side thereof;

FIG. 2 is a cross-sectional view taken along the line X-X of FIG. 1;

FIG. 3 is a cross-sectional view of one part of a mold for use in forming one embodiment of a fuel tank in accordance with the present invention, and shows the state in which a resin sheet is placed on a lower mold;

FIG. 4 is a cross-sectional view of one part of a mold for use in forming one embodiment of a fuel tank in accordance with the present invention, and shows the state in which a thermoplastic synthetic resin adapted to compose an inner resin layer is injected on an interior surface of the outer resin layer; and

FIG. 5 is a cross-sectional view of one part of a mold for use in forming one embodiment of a fuel tank in accordance with the present invention, and shows the state in which the compression molding is carried out after the thermoplastic synthetic resin adapted to compose the inner resin layer is injected on the interior surface of the outer resin layer.

### DETAILED DESCRIPTION OF THE PREFERRED EMBODIMENTS

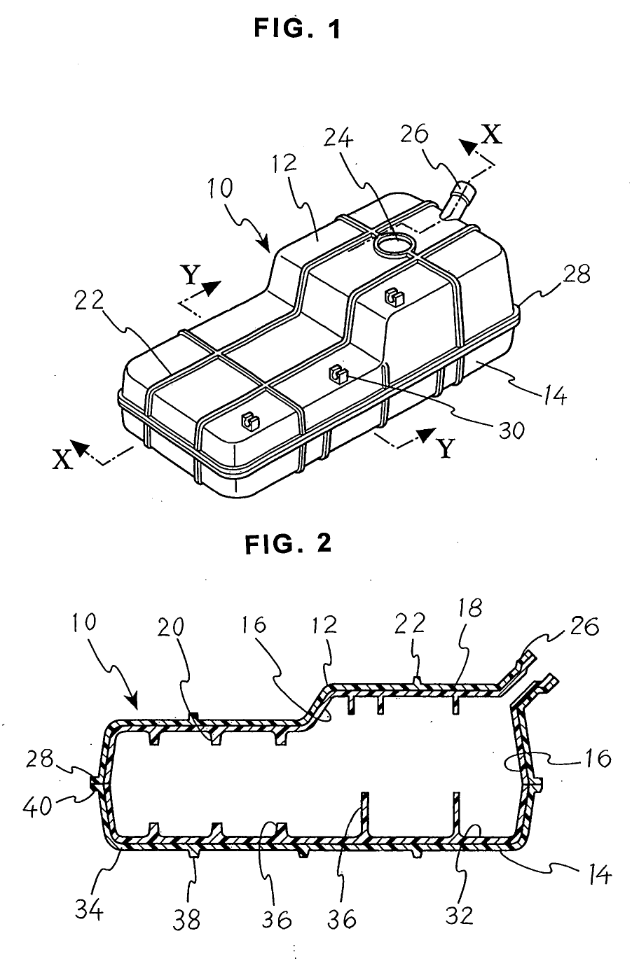

Hereinafter, one embodiment of a fuel tank in accordance with the present invention will be explained with reference to FIGS. 1 and 2. FIG. 1 is a perspective view of a fuel tank 10, which is seen from an obliquely upper side thereof. FIG. 2 is a cross-sectional view taken along the line X-X of FIG. 1.

As shown, the fuel tank 10 includes an upper tank 12 and a lower tank 14 which are formed separately from each other. The fuel tank 10 may be divided into not only two pieces but also three or more pieces. The upper tank 12 includes an inner resin layer 16 and an outer resin layer 18. Ribs 20 as projections are formed integrally with the inner resin layer 16 so as to project inwardly therefrom. Before fusion welding of the upper tank 12 and the lower tank 14, fuel valves, etc. are attached to the ribs 20. And ribs 22, hose clamps 30, etc. are formed integrally with the outer resin layer 18 so as to project outwardly therefrom. The ribs 22 are composed of a plurality of longitudinal ribs and a plurality of transverse ribs. By virtue of these ribs 22, the strength of the upper tank 12 can be increased. The hose clamps 30 are secured to the outer resin layer 18 or integrally formed therewith. Fuel pipes (not shown) and pipes for feeding a fuel evaporation gas (not shown) are secured to the upper tank 12 by means of these hose clamps 30.

A pump unit attaching opening 24 adapted to attach a pump unit inside the fuel tank 10, and a pipe attaching opening 26 adapted to attach a pipe for feeding fuel are provided in the upper tank 12.

An annular flange 28 is formed around an open end of the upper tank 12 so as to project outwardly therefrom.

The lower tank 14 includes an inner resin layer 32 and an outer resin layer 34. Ribs 36 are formed integrally with the inner resin layer 32 so as to project inwardly therefrom. And ribs 38 are formed integrally with the outer resin layer 34 so as to project outwardly therefrom.

An annular flange 40 is formed around an open end of the lower tank 14 so as to project outwardly therefrom.

The flange 28 of the upper tank 12 and the flange 40 of the lower tank 14 are joined by fusion welding, as described later, thereby forming the fuel tank 10.

In the flanges 28 and 40, the inner resin layers 28 and 40 are formed to their peripheral ends so that when the flanges 28 and 40 are fusion welded, the inner resin layers 28 and 40, each exhibiting fuel permeation preventing properties, are brought into close contact with each other. Accordingly, the joined flanges 28 and 40 can prevent fuel from permeating therethrough.

The outer resin layer 18 of the upper tank 12 and the outer resin layer 34 of the lower tank 14 can be respectively composed of a resin sheet of a high density polyethylene (HDPE).

The inner resin layer 16 of the upper tank 12 and the inner resin layer 32 of the lower tank 14 may be respectively composed of at least one kind of a material selected from a group consisting of a copolymer of ethylene vinyl alcohol (EVOH), polyacetal, nylon, polybutylene terephthalate, polyethylene terephthalate and polyphenylene sulfite.

In order to improve the adhesion properties of the inner resin layers 16 and 32 and the outer resin layers 18 and 34, adhesive sheets may be used therebetween. Where the inner resin layers 16 and 32 are respectively composed of a copolymer of ethylene vinyl alcohol (EVOH), and the outer resin layers 18 and 34 are respectively composed of a high density polyethylene (HDPE), each adhesive sheet may be composed of three layers of HDPE/adhesive agent/EVOH which are arranged in this order from the outer side to the inner side thereof. With this arrangement, HDPE composing the outer resin layers 18 and 34 and the copolymer of ethylene vinyl alcohol (EVOH) composing the inner resin layers 16 and 32 are readily fusion welded during the injection molding of the upper tank 12 and the lower tank 14.

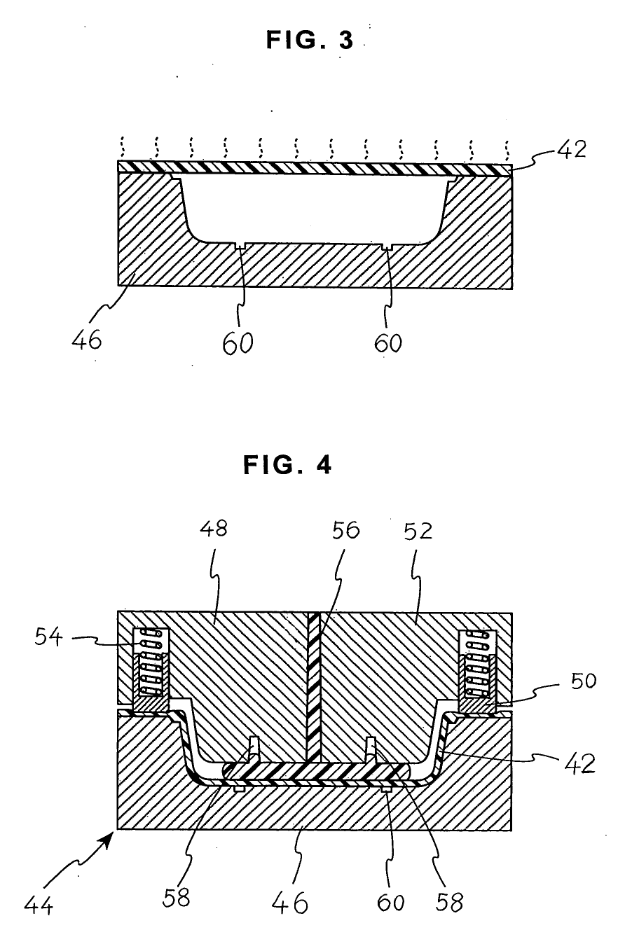

Next, the method for producing the fuel tank 10 will be explained with reference to FIGS. 3 through 5.

As shown, the upper tank 12 and the lower tank 14 are separately formed, and then the flange 28 of the upper tank 12 and the flange 40 of the lower tank 14 are welded together.

First, the method for producing the upper tank 12 and the lower tank 14 will be explained. The upper tank 12 and the lower tank 14 are formed using different molds, but the method for producing these tanks are approximately the same as each other. So, the method for producing the upper tank 12 will be mainly explained.

In order to form the upper tank 12, first, a resin sheet 42 adapted to form the outer resin layer 18 is preheated at a temperature which is not more than the melting point of the resin sheet 42, and facilitates the following preforming process of the resin sheet 42.

In the present embodiment, the resin sheet 42 is preformed in a mold 44 for use in injection molding of the inner resin layer 16. Alternatively, the resin sheet 42 may be preformed with vacuum forming or other forming methods in a preforming mold, and the preformed resin sheet 42 may be placed on a lower mold 46 of the mold 44.

As shown in FIG. 3, the preheated resin sheet 42 is placed on the lower mold 46 of the mold 44. Then, as shown in FIG. 4, an upper mold 48 is closed. The upper mold 48 includes an outer frame 50 and a central mold 52. When the upper mold 48 is closed, the outer frame 50 of the upper mold 48 presses a peripheral area of the resin sheet 42 against the lower mold 46 to hold the resin sheet 42 with the lower mold 46, whereas the central mold 52 of the upper mold 48 is positioned so as to be separated from the lower mold 46 by means of a spring 54 provided in the outer frame 50, thereby defining a cavity with the lower mold 46.

Thus, the upper mold 48 is fitted to the lower mold 46. In the fitted state, the outer frame 50 of the upper mold 48 surrounds the cavity between the lower mold 46 and the upper mold 48, and the central mold 52 is mounted so as to be raised and lowered on the inner side of the outer frame 50.

Next, the central mold 52 is lowered to press the resin sheet 42 against the lower mold 46 to preform the outer resin layer 18. Since the peripheral part of the resin sheet 42 is held with the outer frame 50 of the upper mold 48 and the lower mold 46, the slippage of the resin sheet 42 can be prevented.

Then, the central mold 52 moves upwardly while the peripheral part of the resin sheet 42 is held with the outer frame 50 and the lower mold 46 until a cavity adapted to form the inner resin layer 16 is formed. Next, as shown in FIG. 4, a thermoplastic synthetic resin adapted to compose the inner resin layer 16 is injected from a sprue 56 of the upper mold 48.

By injecting the thermoplastic synthetic resin exhibiting excellent fuel permeation preventing properties on an interior surface of the preformed outer resin layer 18, the inner resin layer 16 having a uniform thickness can be formed. Due to the pressure in the injection molding of the inner resin layer 16, the outer resin layer 18 can be brought into close contact with the lower mold 46 of the mold 44. During the injection molding, the thermoplastic synthetic resin composing the inner resin layer 16, of which the temperature is raised, flows along the interior surface of the outer resin layer 18, and due to heat of the inner resin layer 16, the outer resin layer 18 and the inner resin layer 16 are melted to be closely joined to each other. As a result, with the injection molding, an exterior surface and an interior surface of a resultant upper tank 12 can conform to the configuration of the mold 44, and the bonding of the outer resin layer 18 and the inner resin layer 16 can be facilitated.

Since the resin sheet 42 composing the outer resin layer 18 exhibits high rigidity, the outer resin layer 18 is neither broken nor stretched during the injection molding of the inner resin layer 16.

In addition, since the outer frame 50 of the upper mold 48 strongly presses the resin sheet 42 and the lower mold 46 so that the thermoplastic synthetic resin adapted to compose the inner resin layer 16 can be prevented from being forced out of the mold 44 during the injection molding. And the outer frame 50 can define an end face of one outer rib 22 provided in the outer resin layer 18.

Furthermore, an adhesive sheet may be interposed between the outer resin layer 18 and the inner resin layer 16. The adhesive sheet can be composed of a multi-layered sheet including a layer adapted to be bonded to the outer resin layer 18 and another layer adapted to be bonded to the inner resin layer 16. With this arrangement, the outer resin layer 18 is strongly bonded to the inner resin layer 16 to increase the strength of the fuel tank 10, and prevent the fuel permeation between the outer resin layer 18 and the inner resin layer 16. This adhesive sheet may be integrally bonded to the resin sheet 42 previously.

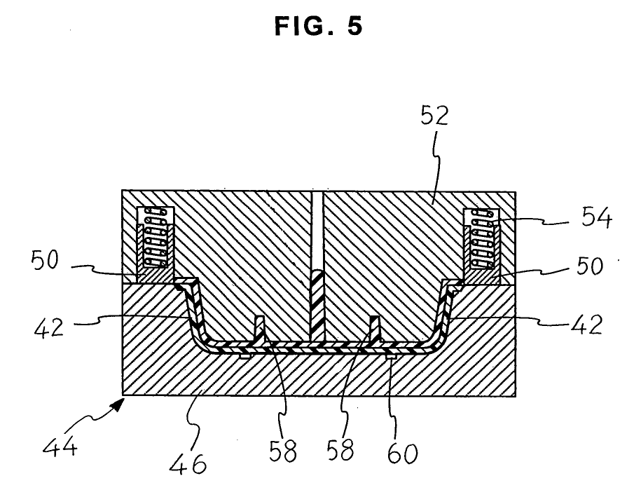

In order to form the ribs 20 in the inner resin layer 16, depressions 58 may be provided in the central mold 52, and in order to form the ribs 22 in the outer resin layer 18, depressions 60 may be provided in the lower mold 46. And in order to fill these depressions 58 and 60 with the thermoplastic synthetic resin sufficiently, as shown in FIG. 5, after injecting the thermoplastic synthetic resin adapted to compose the inner resin layer 16, the central mold 52 is lowered to carry out the injection compression molding to compress the injected thermoplastic synthetic resin.

In addition, by compressing the injected thermoplastic synthetic resin, the adhesive strength of the inner resin layer 16 and the outer resin layer 18 can be increased, and the thermoplastic synthetic resin of the inner resin layer 16 can fill the cavity of the mold 44 entirely.

The lower tank 14 is formed similarly to the formation of the upper tank 12, using a mold including an upper mold and an inner mold for defining a cavity with the upper mold. A thermoplastic synthetic resin is injected in this cavity to mold the lower tank 14 having the flange 40 around an open end thereof.

Next, the process of fusion welding of the upper tank 12 and the lower tank 14 together will be explained.

First, the upper tank 12 and the lower tank 14 are respectively taken out of the molds and secured to holding jigs (not shown). Then, the flange 28 of the upper tank 12 and the flange 40 of the lower tank 14 are respectively melted with a heating plate, etc, to join them together, and are pressed together. At this time, the flanges 28 and 40 are pressed with tip ends of the holding jigs, whereby the flanges 28 and 40 of the upper tank 12 and the lower tank 14 are strongly pressed and fusion welded to become one body. Thus, the fuel tank 10 is produced.

Where built-in parts such as fuel valves, etc. are attached within the fuel tank 10, they are attached to the upper tank 12 or the lower tank 14 prior to the joining thereof. With this method, the built-in parts can be readily attached within the fuel tank 10.

As described above, in accordance with the fuel tank of the present invention, the outer resin layer is composed of a synthetic resin and preformed into a sheet-shaped configuration so that the rigidity thereof can be increased and the wall thickness thereof can be made uniform.

Since the inner resin layer is formed on the interior surface of the outer resin layer by injection molding, the inner resin layer can be uniformly formed inside the outer resin layer. In addition, ribs for attaching built-in parts can be readily formed inside the upper tank and the lower tank.

In accordance with the method of the present invention, the upper tank and the lower tank are separately formed by molding. Before molding, resin sheets adapted to compose the outer resin layers are previously formed so that the outer resin layers can be readily formed of the synthetic resin exhibiting a high rigidity and the thickness thereof can be made uniform.

Since the previously formed resin sheet adapted to compose the outer resin layer is placed in the cavity of the mold, and after the mold is closed, the synthetic resin adapted to compose the inner resin layer is injected to mold the inner resin layer, the inner resin layer with a uniform thickness can be formed on the interior surface of the outer resin layer, and consequently, the outer resin layer can be brought into close contact with the mold while being brought into close contact with the inner resin layer so that both the interior surface and the exterior surface of the fuel tank can conform to the configuration of the mold precisely.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A fuel tank for a motor vehicle comprising:
an upper tank and a lower tank which are respectively composed of a thermoplastic synthetic resin, peripheral parts around open ends of said upper tank and said lower tank being joined together to form the fuel tank, wherein said upper tank and said lower tank are respectively composed of an inner resin layer and an outer resin layer, said outer resin layer is formed by preforming a thermoplastic synthetic resin sheet, said inner resin layer is formed on an interior surface of said outer resin layer by injection molding, and ribs are integrally formed in said inner resin layer so as to project into an interior of said fuel tank.

2. A fuel tank for a motor vehicle as claimed in claim 1, wherein said inner resin layer is composed of a thermoplastic synthetic resin of which the fuel permeation preventing properties are higher than those of said outer resin layer.

3. A fuel tank for a motor vehicle as claimed in claim 1, wherein in said peripheral parts of said upper tank and said lower tank, said inner resin layer of said upper tank and said inner resin layer of said lower tank contact each other and welded together.

4. A fuel tank for a motor vehicle as claimed in claim 1, wherein an adhesive sheet is interposed between said outer resin layer and said inner resin layer, and said adhesive sheet includes a layer adapted to be bonded to said outer resin layer, and another layer adapted to be bonded to said inner resin layer.

5. A method for producing a fuel tank for a motor vehicle, which is composed of an upper tank and a lower tank which are separately molded, and of which peripheral parts around open ends thereof are joined together by fusion welding, wherein said molding step of said upper tank and said lower tank comprises the steps of:
preforming a resin sheet adapted to compose an outer resin layer;
placing said preformed resin sheet in a cavity of a mold; and
injecting a synthetic resin adapted to compose an inner resin layer after closing said mold

6. A method for producing a fuel tank for a motor vehicle as claimed in claim 5, wherein said resin sheet adapted to compose said outer resin layer is preformed by heating said resin sheet and holding said heated resin sheet with said mold.

7. A method for producing a fuel tank for a motor vehicle as claimed in claim 6 wherein said heated resin sheet is held with said mold by pressing a peripheral part of said resin sheet with an outer frame of an upper mold, and a lower mold, lowering a central mold of said upper mold to press said resin sheet with said central mold of said upper mold and said lower mold, and said synthetic resin adapted to compose said inner resin layer is injected after said resin sheet is pressed with said central mold of said upper mold and said lower mold.
